(19) United States
(12) Patent Application Publication
(10) Pub. No.: US 2008/0269991 A1
(43) Pub. Date: Oct. 30, 2008

(54) Activation-Control Device for Occupant Crash-Protection Apparatus

(76) Inventor: Toshiyuki Yamashita, Tokyo (JP)

Correspondence Address: BIRCH STEWART KOLASCH & BIRCH, PO BOX 747, FALLS CHURCH, VA, 22040-0747, US

(21) Appl. No.: 11/884,446

(22) PCT Filed: Dec. 1, 2005
(86) PCT No.: PCT/JP05/22103

§ 371 Date: Aug. 16, 2007

(30) Foreign Application Priority Data
Mar. 28, 2005 (JP) 2005-092180

(51) Int. Cl. B60R 21/0134

(52) U.S. Cl. 701/45

(57) ABSTRACT

A colliding-initial detecting section detects colliding-initial timing at which an impact level detected by an acceleration sensor in the inside of a vehicle reaches a predetermined threshold, and when the colliding-initial timing is detected, a one-shot timer is set. Meanwhile, an impact-judging section detects strong-impact occurrence timing at which the impact level detected by an acceleration sensor on the front reaches a predetermined threshold. When the strong-impact occurrence timing is within a time set by the one-shot timer from the colliding-initial timing, an And circuit outputs an activating signal activating an air bag to a driving section.

### TECHNICAL FIELD

The present invention relates to an activation-control device for an occupant crash-protection apparatus, which ensures a stable actuation of an occupant crash-protection apparatus such as an air bag, provided to protect an occupant from an impact occurred when a vehicle is crashed head-on, according to a collision speed, based on a simple input of the impact.

### BACKGROUND ART

Conventional techniques, connected with an actuation control of an occupant crash-protection apparatus such as an air bag that is provided in a vehicle and protects an occupant chiefly when a vehicle is collided head-on, include, e.g., undermentioned technologies.

As a conventional example 1, this technique is related to an air bag device that deploys one air bag by a plurality of inflators, and an object of the technique is to provide a system of easily judging the severity of an impact at the initial stage thereof, and further, to provide an actuation-control device that allows an easy optimization of an actuation of the inflator according to the degree of severity of the impact. This achieves striving for implementation of optimal deployment of the air bag. The device is arranged such that, apart from an acceleration sensor that is disposed in the inside of a vehicle and successively detects an acceleration in the inside of the vehicle, a crash-zone sensor having a switching function for judging the degree of the collision is disposed in a crash zone that is firstly subject to deformation at the time of collision. This judges the degree of the collision and determines whether or not an actuation of the plurality of inflators is required, and controls the mode of an actuation such as actuation timing (see Patent Document 1, for example).

As a conventional example 2, this technique is connected with an air bag device that deploys one air bag by a plurality of inflators, and an object of this technique is to provide a new actuation-control device of an air bag, which allows an ignition judgment of an air bag at early and proper timing and remarkably reduces a possibility of the occurrence of malfunction of the air bag even in rough roads and hammering conditions. The activation-control device includes a plurality of inflators provided for one air bag, wherein the device include a first acceleration sensor that is provided in the inside of a vehicle and ceaselessly detects an acceleration G, and a second acceleration sensor that is provided in a front crash zone of a vehicle body and incessantly detects acceleration G′; an operation is started from a point of time at which the acceleration signals G, G′ exceeded predetermined values G1, G2; a judgment whether an actuation of the plurality of inflators is required is made based on time integral values V, V′, which are obtained by a time integral; the times t, t′, incurred before the time integral values V, V′ exceed a predetermined value Vs after an operation of the time integral detected by the acceleration sensors is started, are determined; and the mode of an actuation of the plurality of inflators is judged based on the magnitude of a time difference Δt between t and t′ (see Patent Document 2, for example).

As a conventional example 3, an object of this technique is to provide an actuation-control device for an occupant crash-protection apparatus, which actuates the occupant crash-protection apparatus with most suitable timing. The actuation-control device for the occupant crash-protection apparatus includes a floor sensor (acceleration sensor) that is disposed at a predetermined position in the inside of a vehicle body and detects an impact given to the vehicle; and an actuation-control means, in the occupant crash-protection apparatus, for actuating the air bag when the calculated value obtained based on a value detected by the floor sensor exceeds a predetermined threshold; wherein the actuation-control device further includes a satellite sensor (acceleration sensor) that is provided in the front of the floor sensor in the inside of a vehicle, and detects the magnitude of an impact given to the vehicle at a plurality of levels according to the magnitude of the impact; and a threshold-changing means for changing a predetermined threshold into that according to levels of the magnitude of the impact detected by the satellite sensor (see Patent Document 3, for example).

Patent Document 1: Japanese patent No. 3546212

### Patent Document 2: JP-A11-192918

### Patent Document 3: JP-A2000-142311

Conventional techniques related to an activation control of the occupant crash-protection apparatus such as an air bag are arranged as mentioned above, and in any of these arrangements, an acceleration sensor is disposed in the crash zone of the front of a vehicle and the sensor has been used for judgment of the severity of a collision. Further, in any of these arrangements, an acceleration sensor is disposed in the inside of a vehicle, and an acceleration value (impact level) detected by the acceleration sensor is used for an actuation control of the occupant crash-protection apparatus.

However, in the above-mentioned acceleration sensor in the inside of the vehicle, since input timing of the impact to the acceleration sensor is slow, and the impact itself is transmitted through a variety of members of the vehicle, a complicated impact is input thereto. Therefore, when the magnitude of a collision is judged based on the acceleration value detected according to such an input, it can occur a deviation in the sensitivity setting when any member of an impact transmission system is replaced with another one for a case where a delicate judgment is to be made. This results in a stable collision.

Further, in the air bag device (advanced air bag) that deploys one air bag with a plurality of inflators as with the conventional example 1 or the conventional example 2, where an essential function is achieved on the basis of an impact level at the time of collision. The essential function involves not deploying the advanced air bag at the time of low-speed collision; deploying the air bag at low pressure (a first-stage ignition) at the time of medium-speed collision; and normally deploying the air bag (a second-stage ignition) at the time of high-speed collision, there may be a case where the intrinsic function does not necessarily properly actuate.

The present invention has been made to solve the above-mentioned problems, and an object of the present invention is to provide an activation-control device for an occupant crash-protection apparatus, which has an essential function of making a stable collision according to a colliding speed based on a simple input of an impact for stabilization of an activation control of the occupant crash-protection apparatus such as an air bag. Further, in the advanced air bag, the actuation-control device properly actuates the essential function that a colliding speed is discriminated; an air bag is not deployed at the time of low-speed collision; the air bag is deployed at low-pressure at the time of medium-speed collision; and the air bag is normally deployed at the time of high-speed collision.

### DISCLOSURE OF THE INVENTION

The activation-control device for an occupant crash-protection apparatus according to the present invention includes a room acceleration sensor that detects the impact level given to a predetermined position in the inside of a vehicle; a front acceleration sensor detecting an impact level given to a predetermined position in the front; an occupant crash-protection apparatus control means for actuating and controlling the occupant crash-protection apparatus; and a colliding-judgment control section detecting colliding-initial timing at which the impact level detected by the room acceleration sensor reaches a first threshold, detects strong-impact occurrence timing at which the impact level detected by the front acceleration sensor reaches a second threshold, and, when the strong-impact occurrence timing is within a time previously set from the colliding-initial timing, outputs an activation signal, which activates the occupant crash-protection apparatus, to the occupant-protection apparatus control means.

According to the present invention, since it is arranged to detect colliding-initial timing at which an impact level detected by the room acceleration sensor reaches a predetermined threshold; the strong-impact occurrence timing at which the impact level detected by the front acceleration sensor a predetermined threshold is detected; and the strong-impact occurrence timing is within a time previously set from the colliding-initial timing, a colliding judgment can be made based on the magnitude of the impact level, which is input to the front acceleration sensor having a small number of members between its installation place and a place in which a head-on collision is occurred. The reduced members simplify an input of the impact to the acceleration sensor. This enables a stable colliding-judgment and a control, according to a colliding speed based on a simple input of the impact, and permits a stable actuation control of an occupant crash-protection apparatus such as an air bag.

### BRIEF DESCRIPTION OF THE DRAWINGS

FIG. 1 is a block diagram showing a configuration of the activation-control device for an occupant crash-protection apparatus according to the first embodiment of the present invention.

FIG. 2 is a basic configuration diagram of a colliding-initial detecting section or an impact-judging section shown in FIG. 1.

FIG. 3 is a diagram explaining a position relationship of an installation of the main components in a vehicle constituting the activation-control device for the occupant crash-protection apparatus according to the first embodiment of the present invention.

FIG. 4 is an explanation diagram of the colliding-judging operation in the colliding-judgment control section shown in FIG. 1 when a head-on collision is occurred; 4(a) is a timing chart in a case where a colliding speed is high and the collision is strong; 4(b) is a timing chart in a case where a colliding speed is low; 4(c) is a view showing a relationship of an impact G input to the front acceleration sensor to a time; 4(d) is a view showing a relationship of the shock G input to the room acceleration sensor to a time; 4(e) is a view depicting a condition under which a vehicle came into a head-on collision with an collided object; 4(f) is an explanation diagram of an impact input to the room acceleration sensor when a vehicle came into a head-on collision therewith; and 4(g) is an explanation diagram of an impact input to the front acceleration sensor when a vehicle came into a head-on collision therewith.

FIG. 5 is a flowchart showing a processing of a colliding judgment in the colliding-judgment control section shown in FIG. 1 when a head-on collision is occurred.

FIG. 6 is a block diagram showing a configuration of the activation-control device for an occupant crash-protection apparatus according to the second embodiment of the present invention.

FIG. 7 is an explanation diagram concerning an advanced air bag.

FIG. 8 is a view showing a relationship between an impact G input to the front acceleration sensor and a colliding speed, with respect to a time, when a vehicle came into a head-on collision therewith.

FIG. 9 is a block diagram showing a configuration of the activation-control device for an occupant crash-protection apparatus according to the third embodiment of the present invention.

### BEST MODE FOR CARRYING OUT THE INVENTION

Embodiments of the present invention will now be described with reference to the accompanying drawings for explaining in more detail the present invention.

### First Embodiment

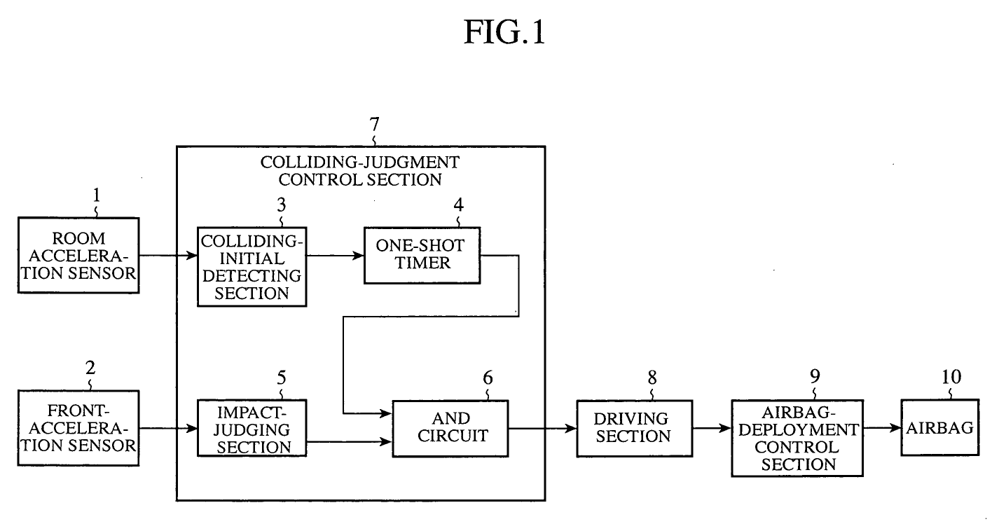

FIG. 1 is a block diagram showing a configuration of the activation-control device for an occupant crash-protection apparatus according to the first embodiment of the present invention. Hereinafter, the explanation will be given with an occupant crash-protection apparatus as an “air bag”.

Referring to FIG. 1, the activation-control device for an occupant crash-protection apparatus is composed of a room acceleration sensor 1 (hereinafter referred to as an “acceleration sensor 1”); a front acceleration sensor 2 (hereinafter referred to as an “acceleration sensor 2”); a colliding-initial detecting section 3; a one-shot timer 4; a impact-judging section 5; an AND (AND) circuit 6; a driving section 8; and an air bag-deployment control section 9.

In the above-mentioned configuration, the acceleration sensor 1 is disposed at a predetermined position in the inside of a vehicle, and is for detecting an impact level given to the installation position thereof. The acceleration sensor 1 inputs an impact occurred at the time of vehicle crash, converts the impact to a voltage signal corresponding to the impact level, and outputs the signal. The acceleration sensor 1 disposed within the main ECU (Electric Control Unit) may place, e.g., in the inside of the center (floor or the like) of a vehicle.

The acceleration sensor 2 is disposed at a predetermined position on the front of the vehicle, and is for detecting the impact level given to the installation position thereof. The acceleration sensor 2 inputs the impact occurred at the time of vehicle crash, converts the impact to a voltage signal corresponding to the impact level and outputs the signal. The input of the impact to the acceleration sensor 2 is comparatively simple as compared with that to the acceleration sensor 1.

The colliding-initial detecting section 3 detects a colliding-initial timing of the vehicle at which the impact level detected by the acceleration sensor 1 reaches a previously set first threshold, based on a signal from the acceleration sensor 1.

The one-shot timer 4 is for outputting a pulse to permit an input judgment by the impact-judging section 5 (mentioned below) for a fixed period of time from the detected colliding-initial timing, when the colliding-initial timing is detected by the colliding-initial detecting section 3.

The impact-judging section 5 judges whether such an impact is indeed occurred based on a signal from the acceleration sensor 2, where the impact level detected by the acceleration sensor 2 is so strong as to reach a previously set second threshold, and detects strong-impact occurrence timing. Here, the second threshold is set to a value larger than that of the first threshold in order to enable detection of a strong impact.

The AND (AND) circuit 6 is for performing a logical product operation of an output of the one-shot timer 4 and that of the impact-judging section 5, and outputs an air bag-activating signal when the strong-impact occurrence timing detected by the impact-judging section 5 is within a fixed period of time set in the one-shot timer 4.

The colliding-initial detecting section 3, the one-shot timer 4, the impact-judging section 5, and the And circuit 6 constitute the colliding-judgment control section 7. This colliding-judgment control section 7 is for performing a processing of the colliding-judgment control based on a signal of the impact level detected by the acceleration sensors 1, 2 as mentioned above, which is composed, e.g., of a microcomputer. Based on the processing of the colliding judgment, the colliding-judgment control section 7 outputs an air bag-activating signal to the driving section 8.

The driving section 8 converts an air bag-activating signal input from the colliding-judgment control section 7 to a driving signal required for a deployment control of the air bag 10 input to the air bag-deployment control section 9 that is a subsequent stage of the driving section, and outputs the signal.

The air bag-deployment control section 9 deploys and controls the air bag 10 in response to a driving signal from the driving section 8.

The driving section 8 and the air bag-deployment control section 9 constitute the occupant crash-protection apparatus control means.

The overall rough operation of the activation-control device for the occupant crash-protection apparatus constituted as described above will be described below.

Signals of the impact level in the inside of a vehicle, detected by the acceleration sensor 1 and the impact level of the front, detected by the acceleration sensor 2 are input to the colliding-initial detecting section 3 and the impact-judging section 5 of the colliding-judgment control section 7, respectively.

The colliding-initial detecting section 3 detects colliding-initial timing at which the impact level detected by the acceleration sensor 1 reaches the first threshold, and when detected the colliding-initial timing, outputs a trigger to the one-shot timer 4 to permit an impact judgment by the shock-judging section 5 for a fixed period of time from the colliding-initial timing.

Meanwhile, the impact-judging section 5 detects strong-impact occurrence timing at which the impact level detected by the acceleration sensor 2 reaches the second threshold. When the strong-impact occurrence timing detected by the impact-judging section 5 is within a fixed period of time set by the one-shot timer 4, an air bag-activating signal is output from the And circuit 6 to the driving section 8.

The driving section 8 outputs a driving signal required for deploying and controlling the air bag 10 to the air bag-deployment control section 9, and the air bag-deployment control section 9 develops and controls the air bag 10.

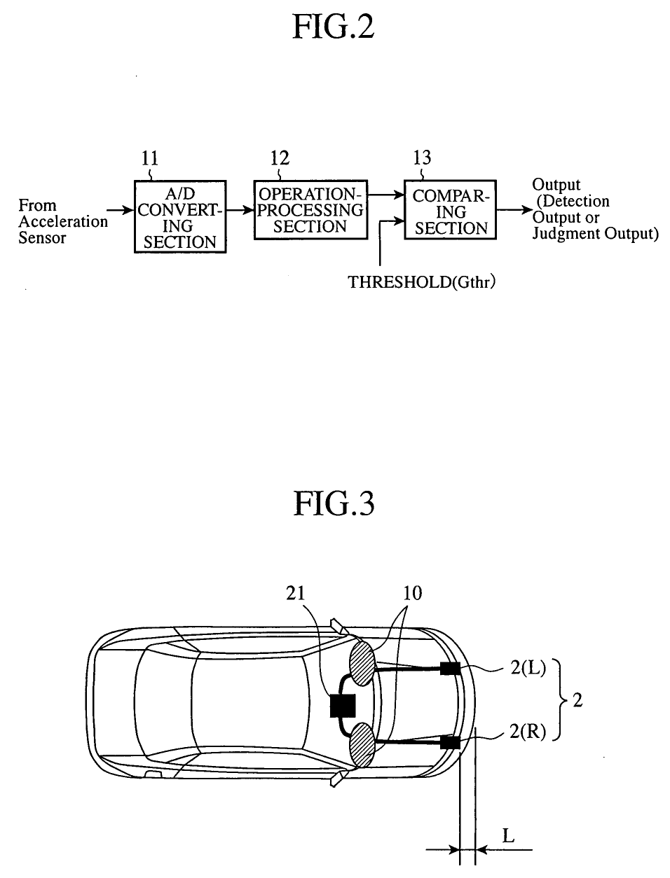

Subsequently, the configuration of the colliding-initial detecting section 3 and the impact-judging section 5 will be described with reference to FIG. 2.

FIG. 2 is a block diagram of the colliding-initial detecting section 3 or the impact-judging section 5 shown in FIG. 1.

Referring to FIG. 2, both of these colliding-initial detecting section 3 and impact-judging section 5 are composed of an A/D converting section 11, an operation-processing section 12, and a comparing section 13, and their configuration result in the same thing. However, needless to say, signals themselves, which are the subject to be processed are different. FIG. 2 shall be commonly used hereinafter in both explanations of the colliding-initial detecting section 3 and the impact-judging section 5.

In this configuration, the A/D converting section 11 converts a voltage signal in analog form corresponding to the impact level detected by the acceleration sensor 1 or the acceleration sensor 2 to a digital signal.

The operation-processing section 12 performs a processing of extracting the magnitude (integral calculus and LPF “Low Pass Filter” processing) of the impact based on the digital signal from the A/D converting section 11.

The comparing section 13 compares a signal being integrated by the operation-processing section 12 with a previously set threshold (Gthr), and outputs the compared results as a detection output or the judgment output. The above-described threshold (Gthr) is a first threshold (Gthr 1) for the colliding-initial detecting section 3, and a second threshold (Gthr 2) for the impact-judging section 5.

Then, a positional relationship of the installation of the above-described constituent components will be described with reference to FIG. 3.

FIG. 3 is an explanation diagram of the main components constituting the activation-control device for the occupant crash-protection apparatus according to the first embodiment of the present invention.

As shown in FIG. 3, at the predetermined left and right positions, are disposed the acceleration sensor 2 (L) and the acceleration sensor 2(R), and in a driver's seat and a passenger's seat, are furnished with air bags 10 to protect occupants at the time of the occurrence of a head-on collision. Further, in the inside of the center of the vehicle is equipped with the main ECU 21, and the main ECU 21 is provided with the acceleration sensor 1 and a variety of control units (colliding-judgment control section 7 and others).

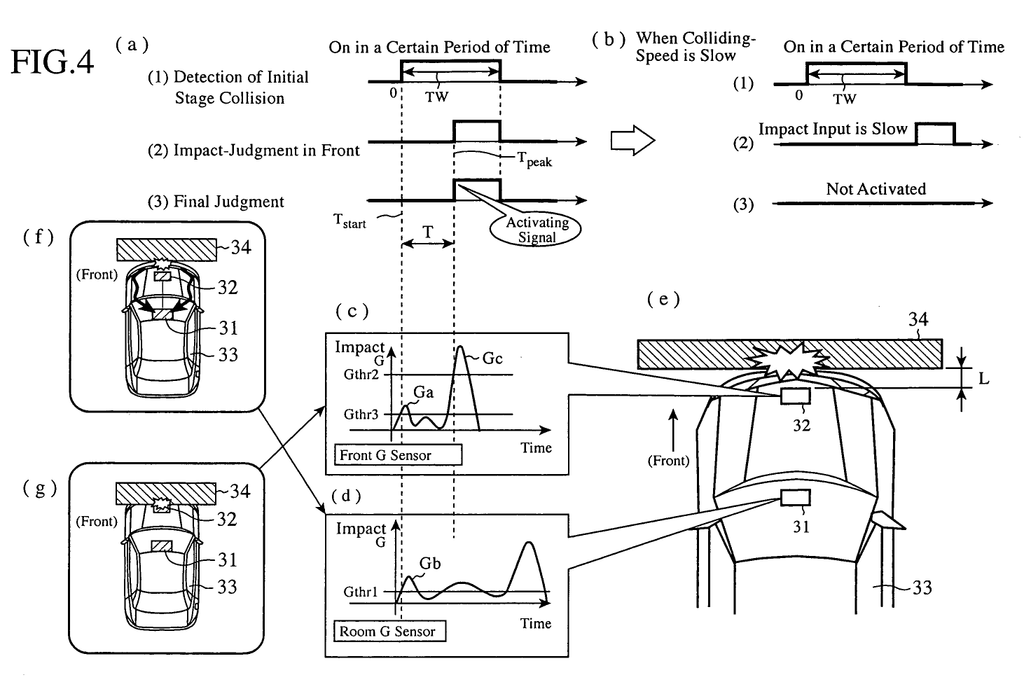

After that, the colliding-judgment operation in the colliding-judgment control section 7 shown in FIG. 1 will be described with reference to FIG. 4.

FIG. 4 is an explanation diagram of a colliding-judgment operation in the colliding-judgment control section 7 shown in FIG. 1 when a head-on collision is occurred. Additionally, referring to FIG. 4, as shown in FIG. 4 (e) and others, a description of the acceleration sensors will be made in passages of the acceleration sensor 31 in the inside of the vehicle and the acceleration sensor 32 disposed in the center of the front of the vehicle. This acceleration sensor 31 corresponds to the acceleration sensor 1 shown in FIG. 1, and the acceleration sensor 32 corresponds to the acceleration sensor 2 shown in FIG. 1.

Referring to FIG. 4, FIG. 4 (a) is a timing chart in a case where a colliding speed is high and a collision is strong; FIG. 4 (b) is a timing chart in a case where a colliding speed is low; FIG. 4 (c) is a view showing a relationship of the impact G (vertical axis) input to the front acceleration sensor 32 to a time (horizontal axis); FIG. 4 (d) is a view showing a relationship of the impact G (vertical axis) input to the inside (floor) acceleration sensor 31 to a time (horizontal axis); FIG. 4 (e) is a view depicting a condition under which a vehicle 33 came into a head-on collision with a collided object 34; FIG. 4 (f) is an explanation diagram of an impact input to the room acceleration sensor 31 when the vehicle 33 came into a head-on collision therewith; FIG. 4 (g) is an explanation diagram of an impact input to the front acceleration sensor 32 when the vehicle 33 came into a head-on collision therewith. Herein, the impacts G (vertical axis) shown in FIGS. 4 (c), 4 (d) are calculated values processed by the operation-processing section 12 explained in FIG. 2.

When the vehicle came into a head-on collision as shown in FIG. 4 (e), in the first-stage of the collision, the impact G is transmitted to the front and the inside of the vehicle as shown in FIG. 4 (f) through the body of the vehicle 33. At that time, as shown in FIGS. 4 (c), 4 (d), and 4 (e), the impacts are input to the acceleration sensor 32 on the front and to the acceleration sensor 31 disposed in the inside of the vehicle, and initial peaks Ga, Gb appear as shown in FIGS. 4 (c), 4 (d). Of these impacts, the impact G input to the acceleration sensor 31 in the inside of the vehicle is compared with the first threshold (Gthr 1) in the comparing section (FIG. 2) of the colliding-initial detecting section 3 as shown in FIG. 4 (d), and a timing at which the input impact G exceeds (reaches) the first threshold is detected. The detected timing is referred to as colliding-initial timing (Tstart) at which a collision starts. This colliding-initial timing (Tstart) is set to “0” in the time (horizontal axis) of FIGS. 4 (a), 4 (b).

With further processing of the collision, the front of the vehicle 33 deforms after that as shown in FIG. 4 (g), and the strong impact G (Gc) is directly input to the acceleration sensor 32 on the front. This input strong impact G (Gc) is compared with the second threshold (Gthr 2) in the comparing section (FIG. 2) of the impact-judging section 5 as shown in FIG. 4 (c), and a timing at which the input strong impact G (Gc) exceeds (reaches) the second threshold is detected. The detected timing is referred to as a strong-impact occurrence timing (Tpeak).

As mentioned hereinabove, a time T from the starting of a collision to an input of the direct impact (strong impact) to the acceleration sensor 32 on the front is expressed as follows:

T=Tpeak−Tstart=L/V (1)

where L is the distance from the front edge of the vehicle 33 to the acceleration sensor 32 on the front as shown in FIG. 4 (e) (or FIG. 3), and V is a colliding speed of the vehicle 33.

As can be understood from the above equation (1), let the distance L to be constant, when a colliding speed V is small (slow), a time T is long (slow), or conversely, when the colliding speed V is long (fast), the time T is short (fast).

Moreover, as shown in FIG. 4 (a) (1), when the colliding-initial timing (Tstart) is detected as previously stated, the colliding-initial detecting section 3 sets the one-shot timer 4, with the colliding-initial timing (Tstart=0 in time) as a starting point, and sets the period of the previously set timer time Tw to the state of HI (actuated) (high “H” level). The signal of FIG. 4 (a) (1) in the state of the high “H” level is input to one end of the AND gate 6.

Further, FIG. 4 (a) (2) shows a state in which a direct impact is input to the acceleration sensor 32 on the front and the strong-impact occurrence timing (Tpeak) is detected by the impact-judging section 5. This state is the high “H” level. The signal of FIG. 4 (a) (2) in the state of the high “H” level is input to the other end of the AND gate 6. When the Tpeak is within the range of the timer time Tw of the above-mentioned FIG. 4 (a) (1), an activating signal to activate the air bag is output from the AND gate 6 as shown in FIG. 4 (a) (3).

As mentioned hereinabove, when a strong impact is input to the acceleration sensor 32 on the front within a fixed period of time (Tw) from the detected colliding-initial timing (Tstart), the air bag is activated.

FIG. 4 (a) described above shows a case where a colliding speed is high and a collision is strong; however, when the colliding speed is slow, an activating signal is not output as shown in FIG. 4 (b).

In FIG. 4 (b), FIG. 4 (b) (1) is the same as FIG. 4 (a) (1), and the state is shown where a collision is occurred, the colliding-initial timing (Tstart) is detected by the colliding-initial detecting section 3, and the one-shot timer 4 is set (Tw) based on this detection.

When a colliding speed is slow, an input timing of the impact to the acceleration sensor 32 on the front is slow, and impact occurrence timing from the impact-judging section 5 is output as shown in FIG. 4 (b) (2). The output shown in FIG. 4 (b) (2) is outside the range of a fixed period of time (Tw) of FIG. 4 (b) (1), and as a result, an output of an AND operation of a signal of FIG. 4 (b) (1) with a signal of FIG. 4 (b) (2), which is performed by the And circuit 6, is LOW (not actuated), and is an output of the signal shown in FIG. 4 (b) (3). The output of the signal restrains the air bag from being activated.

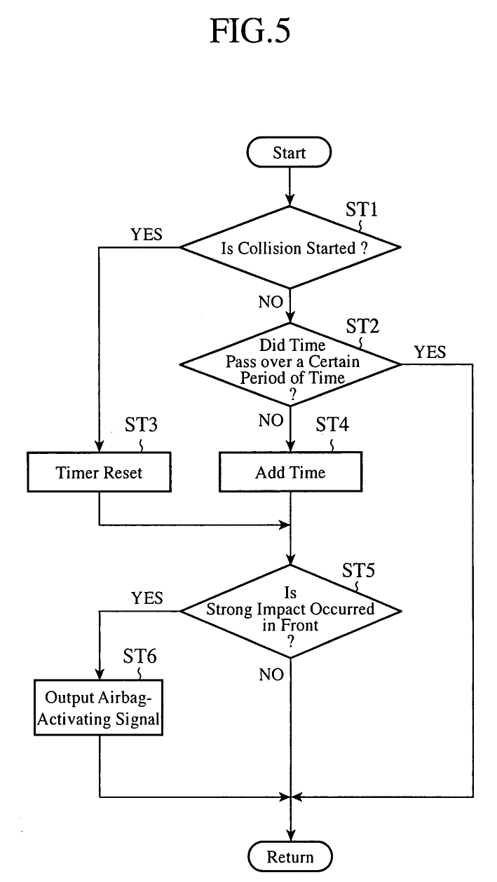

Subsequently, the operation of a colliding judgment in the colliding-judgment control section 7 shown in FIG. 1 will be described following a flowchart shown in FIG. 5.

FIG. 5 is a flowchart showing a processing of a colliding judgment in the colliding-judgment control section 7 shown in FIG. 1 when a head-on collision is occurred.

In the colliding-judgment control section 7 mainly composed of a microcomputer, a judgment on deployment and non-deployment of the air bag 10 is made based on acceleration signal information sampled every several hundred microseconds.

Referring to FIG. 5, in step ST1, the colliding-initial detecting section 3 of the colliding-judgment control section 7 compares an impact level input from the acceleration sensor 1 with the first threshold (Gthr 1) to judge whether a collision is started. In this judgment, if the judgment shows that a head-on collision is not started (step ST1—No), the processing proceeds to step ST2, or else if the judgment shows that a collision is started (step ST1—Yes), the processing proceeds to ST3.

In step ST2, the colliding-judgment control section 7 judges whether a time set by the timer has passed over a fixed period of time, and if the time has passed over a certain period of time (step ST2—Yes), the colliding-judgment control section returns the colliding judgment. This operation shows that there has been no occurrence of a so strong collision as to require an activation of the air bag. Conversely, if the time did not pass over a fixed period of time (step ST2—No), the processing proceeds to step ST4.

In step ST3, if the judgment shows a collision started, the colliding-initial detecting section 3 of the colliding-judgment control section 7 resets the timer (one-shot timer 4), and the colliding-initial detecting section resets the time such that colliding-occurrence timing becomes 0 (colliding-initial timing Tstart) described in FIG. 4 (a) (1). This timer reset means that the time Tw of FIG. 4 (a) (1) is set. After the timer is reset, the processing proceeds to step ST5.

In step ST4, the colliding-judgment control section 7 adds the time, and the processing proceeds to step ST5.

In step ST5, the colliding-judgment control section 7 compares the impact level input from the acceleration sensor 2 with the second threshold (Gthr 2) in the impact-judging section 5 to judge whether a strong impact has occurred in the front within the time Tw set in step ST3. In this judgment, when a strong impact is not occurred (step ST5—No), the colliding-judgment control section returns the colliding judgment. In contrast, if a strong impact is occurred (step ST5—Yes), the processing proceeds to step ST6.

In step ST6, the colliding-judgment control section 7 (And circuit 6) outputs an air bag-activating signal to the driving section 8 based on the judgment of the occurrence of a strong impact, and the colliding-judgment control section returns the colliding judgment.

The driving section 8 to which an air bag-activating signal is input, deploys the air bag 10 through the air bag-deployment control section 9.

In the explanation of FIG. 4, while the colliding-initial timing (Tstart) is detected based on the impact input to the acceleration sensor 31 in the inside of the vehicle (FIG. 4 (d)), the acceleration sensor 32 on the front may make serve a double purpose in lieu of the acceleration sensor 31, and may take, as shown in FIG. 4 (c), timing at which the impact level detected by the acceleration sensor 32 exceeds (reaches) a preset third threshold (Gthr 3) as vehicle-colliding initial-timing (Tstart).

Further, whereas in the explanation of FIG. 4, an example in which the acceleration sensor 32 on the front is disposed at one place of the center of the front is shown (FIG. 4 (e), disposing acceleration sensors at the right and left two places of the front of the vehicle as shown in FIG. 3 enables a colliding judgment similar to the above-described one even in an asymmetrical collision such as an oblique collision or an offset collision. In this case, the shock-judging section 5 shown in FIG. 1 is provided with two systems of arrangements (from the A/D conversion processing to the comparison processing) shown in FIG. 2. Of these two systems of outputs from the comparing section, a colliding judgment has only to be made on a comparison output on the side where the strong-impact occurrence timing (Tpeak) is detected earlier than others.

Furthermore, while the front acceleration sensor 2(32) shown in FIG. 1 or FIG. 4 is implemented as an electronic acceleration (G) sensor, which converts an impact thereto to a voltage signal and outputs the signal, an electromechanical acceleration sensor in the form of an “HI (actuation)” when the input impact is strong may be used instead thereof. In this case, the electromechanical acceleration sensor is previously set such that the sensor executes the HI (actuation) by an impact input corresponding to the second threshold (Gthr 2) used in the impact-judging section 5, and this HI (actuation) signal (high “HI” level signal) is directly input to the And circuit 6 not through the impact-judging section 5. The operation from this forward is the same as that in FIG. 1.

Parenthetically, when the electromechanical acceleration sensor is used as the front acceleration sensor 2 (32), as stated above, the detection of the colliding initial-timing (Tstart) is done by the acceleration sensor 31 in the inside of the vehicle.

As mentioned above, according to the first embodiment, since the occupant crash-protection apparatus is arranged that when the colliding-initial timing (Tstart) at which the impact level detected by the room acceleration sensor 1 reaches the first threshold is detected, the strong-impact occurrence timing (Tpeak) at which the impact level detected by the front acceleration sensor 2 reaches the second threshold is detected, and when the strong-impact occurrence timing is within the time (Tw) previously set from the colliding-initial timing, the occupant crash-protection apparatus is activated, a colliding judgment is made based on the magnitude of the impact level, which is input to the front acceleration sensor 2 having a small number of members between its installation place and a place in which a head-on collision is occurred. Based on a simple input of an impact due to the reduced number of members, a stable colliding-judgment and control are attained according to a colliding speed therebetween, which enables a stabilized activation control of the occupant crash-protection apparatus such as an air bag.

Alternatively, the acceleration sensor 2 (32 (FIG. 4)) on the front may be shared for detection of the colliding-initial timing (Tstart). This combined use allows detection of both of the colliding-initial timing (Tstart) and the strong-impact occurrence timing (Tpeak), by solely using the acceleration sensor (2) on the front, and simplifies the configuration of the device.

### Second Embodiment

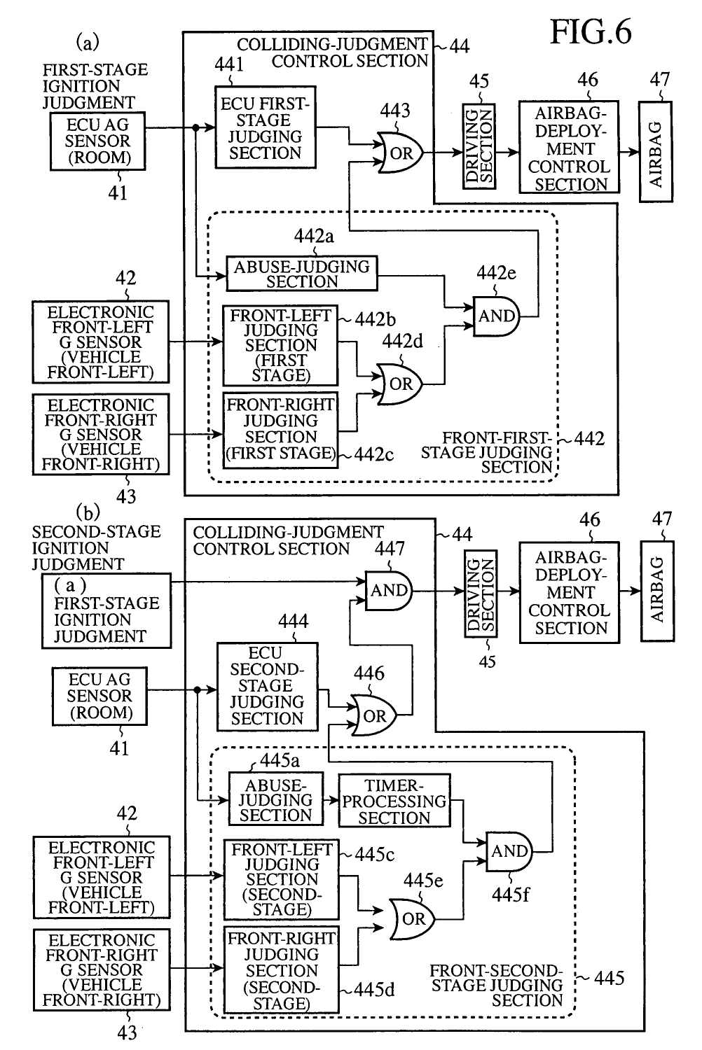

FIG. 6 is a block diagram showing the configuration of an activation-controlling device for an occupant crash-protection apparatus according to the second embodiment of the present invention, 6(a) is a block diagram showing a configuration of a first-state ignition judgment, and 6(b) is a block diagram showing a configuration of a second-stage ignition judgment. It should be appreciated that an explanation will be given hereinbelow by referring an occupant crash-protection apparatus as an “air bag” as with the first embodiment.

The aforementioned activation-control device for the occupant crash-protection apparatus according to the first embodiment is arranged to activate the air bag when a strong impact is occurred on the front within a fixed period of time from the colliding-initial timing in a case where a head-on collision is taken place. The deployment of the air bag by an activation is for bringing it into 100% actuation state (expansive power) of the air bag.

In contrast, the activation-control device for the occupant crash-protection apparatus according to the second embodiment is an activation-control device of the type referred to as an “Advanced Air bag” or “Smart Air bag” adapted to the occupant's physical constitution etc. The air bag is arranged to be activated or controlled in two stages consisting of a first-stage in which the air bag is actuated at a previously lower rate (about 50%, for example) than the rate of a 100% actuating state (expansive power); and a second-stage in which the air bag in the first-stage actuating state is expanded to a 100% actuating state. Here, the first-stage actuation actuates low-pressure deployment based on a first-stage ignition judgment on the premise that a medium speed collision is occurred, and the second-stage actuation means normal deployment based on a second-stage ignition judgment on the assumption that a high speed collision is occurred.

Referring to FIGS. 6 (a), 6 (b), the activation-control device for an occupant crash-protection apparatus is composed of an acceleration sensor (analog acceleration sensor) 41; an electronic front-left acceleration sensor 42; an electronic front-right acceleration sensor 43; a colliding-judgment control section 44; a driving section 45; and an air bag-deployment control section 46.

In the aforementioned configuration, the acceleration sensor 41 (room sensor) is disposed within the main ECU in the inside of the center of the vehicle (floor or the like), and detects the impact level given to the installation position thereof. The acceleration sensor inputs an impact occurred at the time of vehicle crash, converts the impact to a voltage signal corresponding to the impact level and outputs the signal.

The electronic front-left acceleration sensor 42 (front acceleration sensor) is disposed at a predetermined position on the left side of the front of the vehicle, and detects the impact level given to the installation position thereof. The acceleration sensor inputs the impact occurred at the time of vehicle crash, converts the impact to a voltage signal corresponding to the impact level, and outputs the signal.

The electronic front-right acceleration sensor 43 (front acceleration sensor) is disposed at a predetermined position on the right side of the front of the vehicle, and its function is similar to that of the electronic front-left acceleration sensor 42.

The colliding-judgment control section 44 is for processing a colliding judgment of two-stage ignition control of the air bag based on a signal indicative of each of the impact levels detected by the acceleration sensor 41, and is composed, e.g., of a microcomputer. Based on the processing of the colliding judgment, the colliding-judgment control section 44 outputs an activating signal for ignition of the first-stage air bag and further an activating signal for ignition of the second-stage air bag to the driving section 45.

The driving section 45 converts the activating signal of the air bag two-stage control input from the colliding-judgment control section 44 to the driving signal required for ignition of the two-stage control of the air bag 47 performed by the air bag-deployment control section 46 that is a subsequent stage of the driving section, and outputs the signal.

The air bag-deployment control section 46 performs two-stage ignition control of the air bag 47 following a driving signal from the driving section 45.

The driving section 45 and the air bag-deployment control section 46 constitute the occupant crash-protection apparatus control means.

The overall rough operation of the activation-control device for the occupant crash-protection apparatus thus configured as above will be described below.

Signals of the impact level in the inside of a vehicle, detected by the acceleration sensor 41 and the impact level of on the front detected by the electronic front-left acceleration sensor 42 or the electronic front-right acceleration sensor 43 are input to the colliding-judgment control section 44. The colliding-judgment control section 44 performs a processing for a colliding of two-stage ignition control of the air bag based on a signal of each of the impact levels detected by the acceleration sensor 41, the electronic front-left acceleration sensor 42, and the electronic front-right acceleration sensor 43, and outputs an activating signal for the first-stage ignition of the air bag and an activating signal for the second-stage ignition of the air bag to the driving section 45 based on a processing of the collision. The colliding-judgment control processing performed by the colliding-judgment control section 44 will be described hereinafter in detail.

The driving section 45 converts an activating signal of the two-stage control of the air bag to a driving signal required for two-stage ignition control of the air bag 47 performed by the air bag-deployment control section 46 that is a subsequent stage of the driving section, and outputs the signal.

The air bag-deployment control section 46 performs two-stage deployment control of the air bag 47 following a driving signal involving a first-stage ignition and a second-stage ignition.

Then, the details of the configuration and the operation of the colliding-judgment control section 44 will be described below.

The configuration of the colliding-judgment control section 44 includes a different configuration in the first-stage ignition judgment and in the second-stage ignition judgment.

Of these configurations, the first-stage ignition judgment section is composed of an ECU first-stage judging section 441, a front first-stage judging section 442, and an OR (OR) circuit 443 as shown in FIG. 6 (a).

In the above-described configuration, the ECU first-stage judging section 441 judges whether such a strong impact is occurred that the impact level detected by the acceleration sensor 41 is larger than a previously set fourth threshold, and when the judgment shows that a strong impact is occurred, it outputs a judgment signal (high “H” level signal). The ECU first-stage judging section 441 includes the same basic configuration as that explained in FIG. 2. The judging section 441 performs an A/D conversion, integral calculus, and a comparison with the impact level on the basis of the fourth threshold, to a signal indicative of the impact level from the acceleration sensor 41, and when the impact level is larger than the fourth threshold, it outputs a judgment signal (high “H” level signal).

The front first-stage judging section 442 judges whether such a strong impact is occurred that the impact level detected by the acceleration sensor 41 is larger than a previously set fifth threshold, and the impact level detected by the electronic front-left acceleration sensor 42 or the electronic front-right acceleration sensor 43 is larger than a previously set sixth threshold, and when the judgment shows that a strong impact is occurred, it outputs a judgment signal (high “H” level signal). For this purpose, the front first-stage judging section 442 includes an abuse-judging section 442a, which judges by comparing the impact level detected by the acceleration sensor 41 with the fifth threshold; a front-left judging section (first-stage) 442b, which judges by comparing the impact level detected by the electronic front-left acceleration sensor 42 with the sixth threshold; a front-right judging section (first-stage) 442c, which judges by comparing the impact level detected by the electronic front-right acceleration sensor 43 with the sixth threshold; an OR (OR) circuit 442d, which outputs a judgment signal having the strong impact level, out of a judgment signal from the front-left judging section (first-stage) 442b and a judgment signal from the front-right judging section (first-stage) 442c; and an AND (AND) circuit 442e performs an operation of a logical product of a judgment signal from the abuse-judging section 442a and a judgment signal from the OR (OR) circuit 442d, and outputs a judgment signal (high “H” level signal)

The above-described judgment by the front first-stage judging section 442 is mainly made by using the electronic front-left acceleration sensor 42 and the electronic front-right acceleration sensor 43; however, to prevent maldeployment of the air bag caused by a local impact given to these front acceleration sensor sensors 42, 43, the front first-stage judging section 442 takes a configuration in which a logical product of an output from the OR circuit 442d and an output from the abuse judgment (abuse-judging section 442a) is found.

Further, each of the abuse-judging section 442a, the front-left judging section (first-stage) 442b, and the front-right judging section (first-stage) 442c, which constitute the front first-stage judging section 442 having the same configuration as that explained with reference to FIG. 2. The abuse-judging section 442a performs an A/D conversion, integral calculus, and a comparison with the impact level on the basis of the fifth threshold, and outputs a judgment signal (high “H” level signal) when the impact level is larger than the fifth threshold.

Further, each of the front-left judging section (first-stage) 442b and the front-right judging section (first-stage) 442c performs an A/D conversion, integral calculus, and a comparison with an impact level on the basis of the sixth threshold when the impact level of the impact is more than the sixth threshold.

The OR circuit 443 calculates a logical add of a judgment signal from the ECU first-stage judging section 441 and a judgment signal from the front first-stage judging section 442. The output of the OR circuit 443 is an output of the colliding-judgment control section 44 in the first-stage ignition judgment; and an activating signal for the first-stage ignition of the air bag is output to the driving section 45 based on each of the above-described judgments.

Moreover, the second-stage ignition judgment takes an AND configuration, as shown in FIG. 6 (b), which is composed of an ECU second-stage judging section 444, a front second-stage judging section 445, an OR circuit 446, and an AND circuit 447.

In this configuration, the ECU second-stage judging section 444 has the same configuration as that of the ECU first-stage judging section 441 of the first-stage ignition judgment. Hence, the fourth threshold may be set in common with these systems; however, another one may be set.

The front second-stage judging section 445 includes an abuse-judging section 445a; a timer-processing section 445b; a front-left judging section (second-stage) 445c; a front-right judging section (second-stage) 445d; an OR circuit 445e; and an AND circuit 445f.

This front second-stage judging section 445 has a part of which function is fundamentally different from that of the front first-stage judging section 442 of the first-stage ignition judgment and a part of which function is fundamentally the same as that of the judging section 442. This is where a timing difference between rising timing of the impact level detected by the acceleration sensor 41 and timing of the impact level detected by the electronic front-left acceleration sensor 42 or the electronic front-right acceleration sensor 43 is judged as with FIG. 1 of the first embodiment. That is, the front second-stage judging section 445 is different therefrom in that the judging section includes a configuration for detecting colliding-initial timing based on the impact level detected by the acceleration sensor 41 and judging whether a strong impact is occurred within a fixed period of time (Tw) from the detected colliding-initial timing in the electronic front-left acceleration sensor 42 or the electronic front-right acceleration sensor 43. The judgment on the timing difference, which constitutes the above-described difference, is made by the abuse-judging section 445a and the timer-processing section 445b.

The abuse-judging section 445a detects colliding-initial timing at which the impact level detected by the acceleration sensor 41 reaches the fifth threshold by using the fifth threshold set in the abuse-judging section 442a of the front first-stage judging section 442, and the colliding-initial timing is detected, the timer-processing section 445b is set such that an impact judgment made by the front-left judging section (second-stage) 445c and the front-right judging section (second-stage) 445d is permitted only for a fixed period of time (Tw).

The front-left judging section (second-stage) 445c and the front-right judging section (second-stage) 445d are the same in each of the systems and the fundamental functions as those of the front-left judging section (first-stage) 442b and the front-right judging section (first-stage) 442c of the first-stage ignition judgment, and therefore an explanation thereof is omitted for economy of space.

In addition, the OR circuit 445e and the AND circuit 445f are the same in the fundamental functions as that of the OR circuit 442d and the AND circuit 442e of the first-stage ignition judgment, respectively, and an explanation thereof is omitted for economy of space.

With the above-mentioned system, the front second-stage judging section 445, when a judgment signal (high “H” level signal) is output from the front-left judging section (second-stage) 445c or the front-right judging section (second-stage) 445d within a fixed period of time (Tw) set by the timer-processing section 445b, outputs a judgment signal (high “H” level signal) of a front strong impact level occurrence. The judgment operation of the front second-stage judging section 445 is similar to that of FIG. 4 mentioned above.

The function of the OR circuit 446 is similar to that of the OR circuit 443 in the first-stage ignition judgment, and executes a logical add of a judgment signal from the ECU second-stage judging section 444 and a judgment signal from the front second-stage judging section 445. That is, when a judgment signal (high “H” level signal) of the strong impact-level occurrence is output from either of the ECU second-stage judging section 444 and the front second-stage judging section 445, the OR circuit 446 outputs a judgment signal (high “H” level signal) indicating to that effect. This output of the OR circuit 446 becomes a signal determining the second-stage ignition of the air bag. This output of the OR circuit 446 is input to the AND circuit 447.

The And circuit 447 calculates a logical product of an activating signal for the first-stage ignition of the air bag with a signal determining the second-stage ignition of the air bag from the OR circuit 446. This output of the OR circuit 447 becomes an output of the colliding-judgment control section 44 in the second-stage ignition judgment; and when a judgment signal (high “H” level signal) indicative of a strong impact-level occurrence is output from the OR circuit 446 based on each of the judgments mentioned above, an activating signal for the second-stage ignition of the air bag is output to the driving section 45. Further, the provision of the And circuit 447 sets a premises that the first-stage ignition is mandatory to output an activation signal for the second-stage ignition of the air bag.

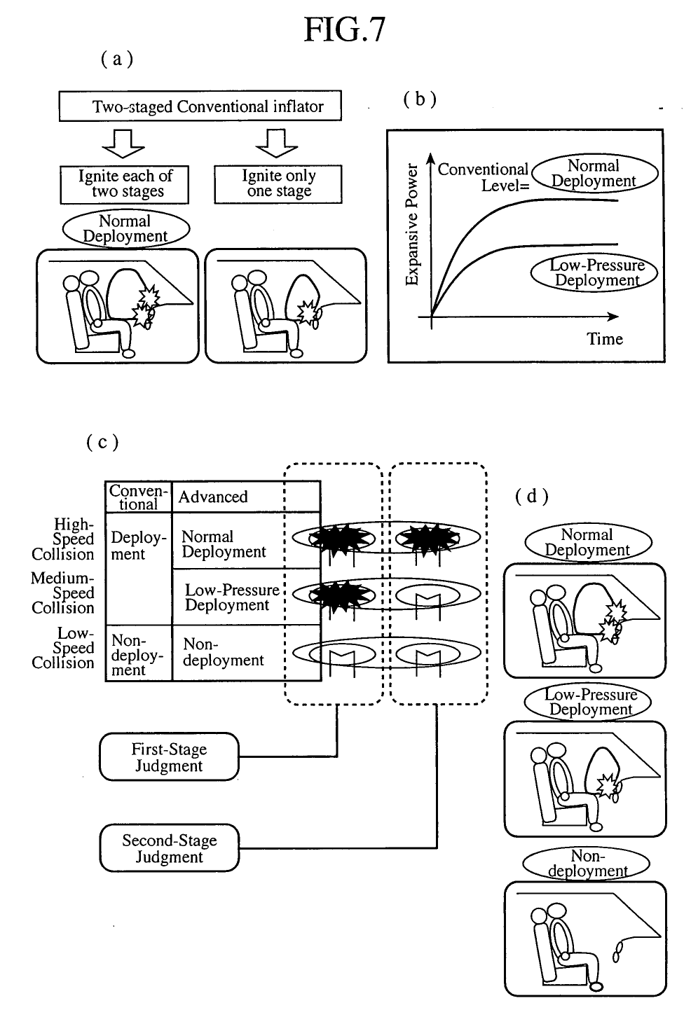

Subsequently, an advanced air bag will be explained with reference to FIG. 7.

FIG. 7 is an explanation diagram concerning an advanced air bag.

The advanced air bag according to the second embodiment is arranged such that a damage given by the air bag is reduced by adapting the air bag to a passenger's physical constitution, and an expansive power of the air bag is properly controlled according to its colliding speed. As shown in FIG. 7 (a), the air bag is arranged to actuate in two stages: low-pressure deployment in which an inflator ignites only one stage, which is included in the air bag-deployment control section 46 shown, e.g., in FIG, and generating gas for air bag deployment; and normal deployment in which the inflator ignites both of the two stages. The relationship of time-expansive power for each of the low-pressure deployment and the normal deployment is shown in FIG. 7 (b). The normal deployment in which the two stages are ignited corresponds to that of the conventional air bag, which has not taken a two stage arrangement, and an expansive power for the low-pressure deployment is set at about one-half (about 50%) of that for the normal deployment as shown in FIG. 7. Further, the relationship between colliding speeds of the vehicle and deployment of the air bag are shown in FIG. 7 (c). As shown in FIG. 7 (c), the conventional air bag which has not taken a two-stage arrangement, is deployed (normal deployment) in the same manner in the high-speed collision and also in the medium-speed collision, and is not deployed in the low-speed collision. On the contrary, the advanced air bag is normally deployed in the high-speed collision, is deployed at low-pressure in the medium-speed collision, and is not deployed in the low-speed collision. As to whether either of the normal deployment or the low-pressure deployment has to be selected, a judgment is required therefor, that is, the first-stage judgment judges is for the low-pressure deployment and the second-stage judgment judges is for the normal deployment. The conditions of the normal deployment, low-pressure deployment, and non-deployment are illustrated in FIG. 7 (d) in connection with an occupant and the expanded air bag.

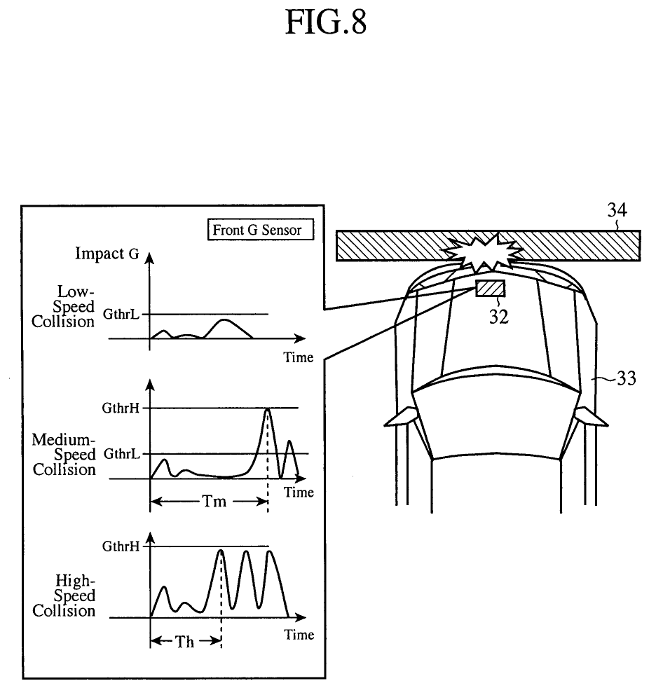

Then, the reason why the activation-controlling device is arranged as shown in FIG. 6 will be given with reference to FIG. 8.

FIG. 8 is a view showing a relationship of the input impact G and colliding speeds to a time, input to the acceleration sensor 32 (front acceleration sensor) disposed on the front of a vehicle 33 when the vehicle 33 came into a head-on collision with a collided object 34. “GthrL” and “GthrH” in FIG. 8 are a previously set threshold on the low (L) side and a previously set threshold on the high (H) side, respectively. Here, it should be noted that the acceleration sensor 32 shown in FIG. 8 corresponds to the electronic front-left acceleration sensor 42, or to the electronic front-right acceleration sensor 43 shown in FIG. 6.

In FIG. 8, when a collision is befallen at a low speed, the threshold is less than the threshold GthrL, the resultant deformation does not extend to an installation portion of the acceleration sensor 32, and the strong impact G is not occurred. In contrast, in the medium-speed collision and the high-speed collision, the threshold exceeds the threshold GthrL and approaches the threshold GthrH, and the deformation is extended to the installation portion of the acceleration sensor 32, thereby giving rise to a strong impact G.

As described above, as for the threshold for the first-stage ignition judgment of the air bag, the judgments on the low-speed collision and the medium-speed collision can be made by setting the GthrL such that the air bag is not deployed at the time of low-speed collision. However, as for the second-stage ignition judgment, when the GthrH is set such that the air bag is not deployed at the time of medium-speed collision, there can be a case where the air bag is not HI actuated or not deployed in a high-speed collision. In particular, when the collided object is deformed as with the case of a collision between a vehicle and a vehicle, it is not liable to occur the impact G, even in a high-speed collision.

Accordingly, it is difficult to appropriately discriminate collisions between a high-speed collision and a medium-speed collision on the basis of the impact level G input to the acceleration sensor 32, and there can be a case where it is hard to normally deploy the air bag in a high-speed collision and deploys the air bag at low-pressure in a medium-speed collision, as described in FIG. 7 (c).

However, as can be understood by comparison of the medium-speed collision and the high-speed collision shown in FIG. 8, there is a difference in the timing at which the strong impact G exceeding the GthrL is input to the acceleration sensor 32 between the medium-speed collision and the high-speed collision, and input timing Th at the time of high-speed collision is earlier than input timing Tm at the time of medium-speed one. Making use of a difference between the input timing Tm and the input timing Th, it becomes possible to properly distinguish between the high-speed collision and the medium-speed collision. The configuration shown in FIG. 6 is arranged to make a proper discrimination between the high-speed collision and the medium-speed collision by making use of a difference in the input timing of the impact G input to the acceleration sensor 32.

As mentioned above, according to the second embodiment, it is arranged that, when the impact level detected by the room acceleration sensor 41 is larger than the forth threshold, or when the impact level detected by the acceleration sensor 41 is larger than the fifth threshold, and the impact level detected by the electronic front-left acceleration sensor 42 or the electronic front-right acceleration sensor 43, disposed on the front, is larger than the sixth threshold, the colliding-judgment control section 44 outputs an activating signal for the first-stage ignition of the air bag to the driving section 45. Moreover, after the first-stage ignition, when the impact level detected by the acceleration sensor 41 is larger than the forth threshold, or when the colliding-initial timing (Tstart) at which the impact level detected by the acceleration sensor 41 reaches the fifth threshold is detected, while the strong-impact occurrence timing (Tpeak) at which the impact level detected by the electronic front-left acceleration sensor 42 or the electronic front-right acceleration sensor 43 reaches the sixth threshold is detected, and the strong-impact occurrence timing is within the time previously set from the colliding-initial timing, the colliding-judgment control section 44 outputs an activating signal for the second-stage ignition of the air bag to the driving section 45. Thus, it becomes possible to distinguish between the medium-speed collision and the high-speed collision. This allows a proper actuation of the essential function of the advanced air bag that the air bag is not deployed at the time of low-speed collision; the air bag is deployed at a low-pressure by a first-stage ignition at the time of medium-speed collision; and the air bag is normally deployed by a second-stage ignition at the time of high-speed collision, thus improving reliability of the advanced air bag.

### Third Embodiment

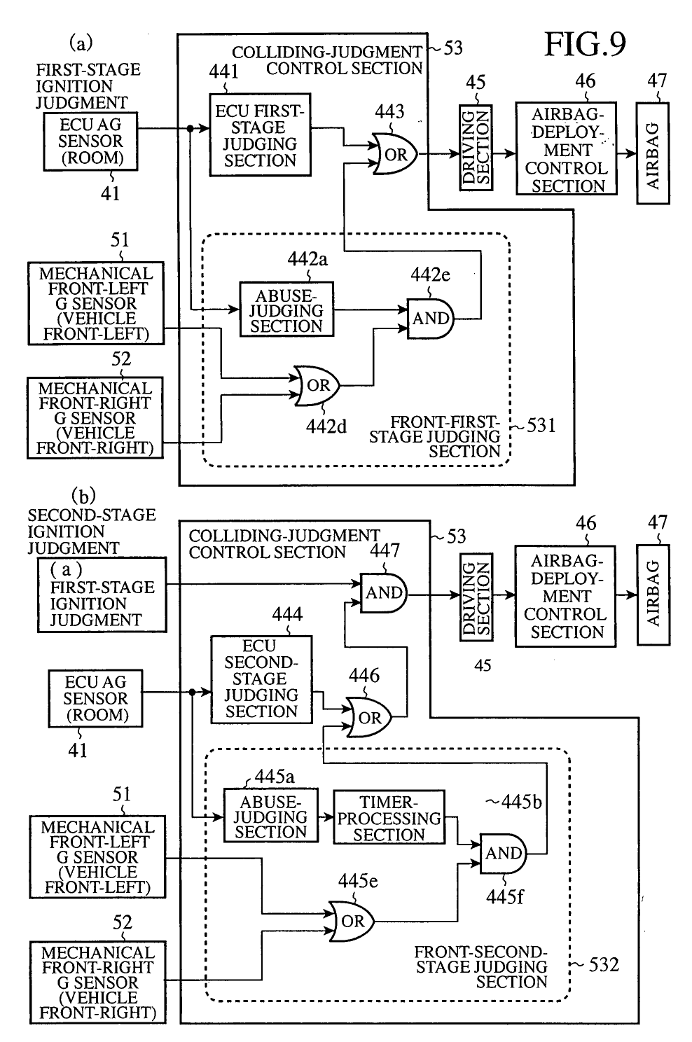

FIG. 9 is a block diagram showing a configuration of an activation-control device for an occupant crash-protection apparatus according to the third embodiment of the present invention, 9(a) is a block diagram showing a configuration of a first-stage ignition judgment, and 9(b) is a block diagram showing a configuration of a second-stage ignition judgment. It should be appreciated that the explanation will be given hereinbelow by referring to an occupant crash-protection apparatus as an “air bag” as with the first embodiment.

Referring to FIG. 9, the activation-control device for the occupant crash-protection apparatus according to the third embodiment is arranged by providing an electromechanical (mechanical) front-left acceleration sensor 51 and an electromechanical front-right acceleration sensor 52 in place of the electronic front-left acceleration sensor 42 and the electronic front-right acceleration sensor 43 in the activation-controlling device for the occupant crash-protection apparatus (FIG. 6) of the advanced air bag according to the second embodiment; and a colliding-judgment control section 53 installed on the condition that these electromechanical front acceleration sensors 51, 52 are used. Additionally, the same components as that of FIG. 6 are designated by the same reference numerals, and an explanation thereof is omitted for economy of space.

The previous sensitivity setting such that these electromechanical front acceleration sensors 51, 52 are an HI (actuation) type when a strong impact is input, and the air bag is not deployed at the time of low-speed collision enables the advance air bag not to be ignited. In correct terms, these electromechanical front acceleration sensors 51, 52 are generally a spring-bus type, and its mass overpowers a spring repulsion when a strong impact is input thereto and the mass moves, when a strong impact is input thereto, and when the movement becomes more than a certain value, the sensors are energized (HI (actuated)). These sensors are more inexpensive than electronic sensors. However, these electromechanical front acceleration sensors 51, 52 is permitted only one sensitivity-setting, and therefore, these sensors HI actuate at the time of medium-speed collision and also high-speed collision, which makes it impossible to distinguish between the two collisions. For this reason, the above-described electronic acceleration sensors shown in FIG. 6 have been used in the conventional a two-stage ignition control of the air bag.

On the contrary, the activation-control device for occupant crash-protection apparatus according to the third embodiment can make a discrimination between the medium-speed collision and the high-speed collision as with the configuration shown in FIG. 6 by using rising of the impact level input to the acceleration sensor 41 in the inside of a vehicle as colliding-initial timing (Tstart); and by identifying a time from the colliding-initial timing before the electromechanical front-left acceleration sensor 51 or the electromechanical front-right acceleration sensor 52 HI is actuated.

As described above, the electromechanical front-left acceleration sensor 51 and the electromechanical front-right acceleration sensor 52 are an HI type (actuation) when a strong impact is input, and they are different from the electronic front-left acceleration sensor 42 and the electronic front-right acceleration sensor 43 shown in FIG. 6, which output a voltage signal corresponding to the impact level. Therefore, the front-left and the front-right acceleration sensors eliminate the need for an A/D conversion, integral calculus, and a comparison on the basis of the threshold, to a signal of the impact level, which eliminates the need to provide the front-left judging section (first-stage) 442b, the front-right judging section (first-stage) 442c, the front-left judging section (second-stage) 445c, and the front-right judging section (second-stage) 445d, shown in FIG. 6. In these circumstances, the front first-stage judging section 531 and the front second-stage judging section 532 of the colliding-judgment control section 53 are arranged as shown in FIGS. 9 (a), 9 (b). When sensitivity is previously set such that each of the electromechanical front-left acceleration sensor 51 and the electromechanical front-right acceleration sensor 52 do not actuate by an impact occurred at the time of low-speed collision and HI actuate by the impact occurred at the time of medium-speed collision and high-speed collision; and when each of these acceleration sensors 51, 52 HI actuated based on the sensitivity-setting, the “HI (actuation) signal (high “H” level signal) is directly input to the OR circuit 442d in the front first-stage judging section 531, and is directly input to the OR circuit 445e in the front second-stage judging section 532.

Accordingly, when the “HI (actuation) signal” is input from the electromechanical front-left acceleration sensor 51 or the electromechanical front-right acceleration sensor 52, the OR circuit 442d in the front first-stage judging section 531 in a first-stage ignition judgment of FIG. 9 (a) sends the “HI (actuation) signal” to the And circuit 442e. The operation from this forward is the same as that described in FIG. 6 (a), and an explanation thereof is omitted for economy of space.

Further, when an “HI (actuation) signal” is input from the electromechanical front-left acceleration sensor 51 or the electromechanical front-right acceleration sensor 52, the OR circuit 445e in the front second-stage judging section 532 in the second-stage ignition judgment shown in FIG. 9 (b) sends in a like manner the “HI (actuation) signal” to the And circuit 445f. The operation from this forward is the same as that described in FIG. 6 (b), and an explanation thereof is omitted for economy of space.

As described hereinabove, an activating signal for the first-stage ignition of the air bag based on a first-stage ignition judgment, and further, an activating signal for a second-stage ignition based on a second-stage ignition judgment are arranged to be output from the colliding-judgment control section 53 provided on the assumption that the electromechanical front-left acceleration sensor 51 and the electromechanical front-right acceleration sensor 52 are used to the driving section 45.

As described above, according to the third embodiment, since it is arranged that the electromechanical front-left acceleration sensor 51 and the electromechanical front-right acceleration sensor 52 be provided in place of the electronic front-left acceleration sensor 42 and the electronic front-right acceleration sensor 43 of the activation-control device for the occupant crash-protection apparatus of the advanced air bag type according to the above second embodiment, and the colliding-judgment control section 53 make a colliding judgment on the premise that these electromechanical front acceleration sensors 51, 52 are provided therein, it simultaneously allows a discrimination between a medium-speed collision and a high-speed collision even by these electromechanical front acceleration sensors 51, 52 as with the case where the electronic front acceleration sensors 42, 43 are used. This provides an inexpensive two-stage ignition control of the air bag, in which electromechanical acceleration sensors are used.

### INDUSTRIAL APPLICABILITY

As described hereinabove, the activation-controlling device for the occupant crash-protection apparatus according to the present invention implements a stable collision according to a colliding speed based on a simple impact input, the device can stabilize an activation control of the occupant crash-protection apparatus such as an air bag, and the activation-control device is suitable for use in the occupant crash-protection apparatus used in a vehicle or the like.

1. An activation-control device for an occupant crash-protection apparatus comprising:
a room acceleration sensor that is provided at a predetermined position in the inside of a vehicle, and detects an impact level given to its installation position;
a front acceleration sensor that is provided at a predetermined position in the front of the vehicle, and detects an impact level given to its installation position;
an occupant crash-protection apparatus control means for actuating and controlling the occupant crash-protection apparatus; and
a colliding-judgment control section that detects colliding-initial timing at which the impact level detected by the room acceleration sensor reaches a preset first threshold, detects strong-impact occurrence timing at which the impact level detected by the front acceleration sensor reaches a second threshold, which is previously set to a value larger than the first threshold, and, when the strong-impact occurrence timing is within a time previously set from the colliding-initial timing, outputs an activating signal activating the occupant crash-protection apparatus to the occupant crash-protection apparatus control means.

2. The activation-control device for an occupant crash-protection apparatus according to claim 1, wherein the colliding-judgment control section shares the front acceleration sensor in place of the room acceleration sensor, and detects timing at which the impact level detected by the front acceleration sensor reaches a preset third threshold, as colliding-initial timing.

3. The activation-control device for an occupant crash-protection apparatus according to claim 1, wherein the front acceleration sensor is an electromechanical acceleration sensor.

4. An activation-control device for an occupant crash-protection apparatus comprising:
a room acceleration sensor that is provided at a predetermined position in the inside of a vehicle, and detects an impact level given to its installation position;
a front acceleration sensor that is provided at a predetermined position in the front of the vehicle, and detects an impact level given to its installation position;
an occupant crash-protection apparatus control means for controlling an occupant crash-protection apparatus by dividing an actuation of the protection apparatus into a first-stage actuation and a second-stage actuation, which are partially actuated in the occupant crash-protection apparatus; and
a colliding-judgment control section, when the impact level detected by the room acceleration sensor is more than a preset forth threshold, or when the impact level detected by the room acceleration sensor is more than a preset fifth threshold, and the impact level detected by the front acceleration sensor is more than a sixth threshold, which is previously set to a value larger than the fifth threshold, outputs an activating signal causing the occupant crash-protection apparatus to get into a state of the first-stage actuation to the occupant crash-protection apparatus control means; and after the first-stage actuation is activated, when the impact level detected by the room acceleration sensor is more than the forth threshold, or when colliding-initial timing at which the impact level detected by the room acceleration sensor reaches the fifth threshold is detected, while strong-impact occurrence timing at which the impact level detected by the front acceleration sensor reaches the sixth threshold is detected, and the strong-impact occurrence timing is within a time previously set from the colliding-initial timing, outputs an activating signal causing the occupant crash-protection apparatus to get into a state of the second-stage actuation to the occupant crash-protection apparatus control means.

5. The activation-control device for an occupant crash-protection apparatus according to claim 4, wherein the front acceleration sensor is an electromechanical acceleration sensor.
